(19) United States
(12) Patent Application Publication
(10) Pub. No.: US 2009/0060173 A1
(43) Pub. Date: Mar. 5, 2009

(54) Germ protector system for telephone

(76) Inventor: Lonnie G. Williams, Cypress, TX (US)

Correspondence Address: DARCELL WALKER, 8107 CARVEL LANE, HOUSTON, TX, 77036, US

(21) Appl. No.: 11/897,603

(22) Filed: Aug. 31, 2007

(51) Int. Cl. H04M 1/00

(52) U.S. Cl. 379/452

(57) ABSTRACT

Germ protector system provides covers for both the receiver and transmitter portions of a telephone device along a connecting element that connects the receiver and transmitter covers. The covers provide a protective barrier to prevent germs from contacting the surfaces of the end pieces of a telephone device. The connecting element provides a convenient means to remove the covers from the telephone once the user has completed a conversation on the telephone device. With this connecting element, the user can remove the covers without the need for the user to contact the contaminated covers.

### FIELD OF THE INVENTION

The present invention relates to germ protective telephone covers and, more particularly, to sterile disposable telephone headset covers that fit over the receiver and transmitter ends of a telephone headset. The invention contains telephone covers that fit over the receiver and transmitter ends of the telephone headset such that a user can remove the covers after use without physical contact with the used telephone covers.

### BACKGROUND OF THE INVENTION

Communicating with someone on a telephone is a common activity done by most people on a daily basis. However, this activity can also be one of the more unsanitary activities as well. Especially when multiple people use the same telephone device, transmission of germs from one person to another person via the telephone device becomes a very common act.

Although many people use cellular telephones and therefore do not have the problem of transmitting germs through multiple telephone users, there are still many public locations where telephone handsets are used by several people such as in telephone booths or telephone s in airports, train stations, schools, hospitals and other public facilities, it is desirable to provide some degree of protection to the public using these telephones. There is no doubt that various diseases may be communicated because of germs in the telephone mouthpiece, handle or earpiece. The telephone handsets rarely are cleaned and, since frequent cleansing is improbable, it has been suggested that various covers be used to provide a degree of protection. Most covers used for this purpose do not cover the entire handset but rather cover either the mouthpiece or part of the handle and mouthpiece. It is common that germs can be just as easily communicated to others from the handle as well as the mouthpiece or earpiece. This fact is especially true in hospitals where patients with a variety of communicable diseases use the same telephones. It is desirable to have a disposable, simple, inexpensive telephone cover that will provide adequate protection and yet not interfere with clear voice transmission and reception.

Many attempts have been made to provide a physical barrier between a user and the telephone device. These attempts have involved the use of materials, which may provide an impervious barrier, and hence muffle sound or distort voice transmission, or those that have perforations or are wettable, and hence can transport the bacteria from the telephone to the mouth, and visa versa. Barriers are used to cover the mouthpiece, the earpiece, and mouthpiece, and sometimes the handle. When away from home, a person's hands are more easily washed than the face or ears; hence covers for the earpiece have real usefulness. Individually packaged towelettes, and liquid products that allege to disinfect the hands without water, are readily available. In addition, gloves may be used. Covers for the entire earpiece and mouthpiece have also been attempted, but most of them are too cumbersome for a traveler.

Some of these covers are the types disclosed in U.S. Pat. Nos. Des. 214,322; 2,078,877; 2,507,375; 3,304,379; 3,962,555; 4,570,038 and 4,736,418. In U.S. Pat. No. Des. 214,322 a disposable handset cover is illustrated which covers only a portion of the telephone handle. Medical authorities agree that germs can be spread from hand contamination as well as through the ear, nose and mouth. The type of handset cover in U.S. Pat. No. Des. 214,322 does not cover the entire handle and thus does not provide adequate protection to the user. In U.S. Pat. No. 2,078,877 (Hoyland) an antiseptic device is disclosed which fits over the mouthpiece of the telephone. Again, in devices of this type, there is no protection from germs transmitted from the handle or earpiece. In U.S. Pat. No. 2,507,375 (Hartwell) another protective device is disclosed which only covers the mouthpiece of a telephone. There is no cover protection from germs located in the handle or earpiece. In U.S. Pat. No. 3,304,379 (Memmel) a protective, hygienic cover is disclosed for use over mouthpieces or earpieces of telephones. There is no protection provided by Memmel for germs that can be transmitted from the hand piece or handle of the telephone. In U.S. Pat. No. 3,962,555 (Efaw) a telephone guard is disclosed which covers the mouthpiece and the earpiece (receiver) and only a portion of the handle. This type guard does not reduce the spread of germs found on the uncovered portion of the handle. In U.S. Pat. No. 4,570,038 (Tinelli) a sanitary cover is disclosed for use over the sound transmitting portion of a telephone handset, either or both the mouthpiece and the receiver. No provision is made in Tinelli for covering the handset or portions other than the “sound transmitting portions of telephones”. Thus, the handle portion, which also can spread germs, is left unprotected in devices such as Tinelli's. U.S. Pat. No. 4,736,418 (Steadman) discloses a telephone cover, which covers the entire handset to make the handset more decorative and attractive. When Steadman covers the entire telephone she uses annular rings on the earpiece and mouthpiece. In the second embodiment of Steadman the mouthpiece and earpiece are left open. Steadman's device is intended to be decorative. Steadman's cover is relatively complex and expensive since it requires annular rings that fit over both the mouthpiece and earpiece and apparently provides cushioning means. These cushioning means are suggested by Steadman to be made from foam or cotton. These cushions themselves can accumulate and transmit germs to the user. The cover of Steadman is reusable and washable and can be made from “cotton or silk or wool or synthetics such as nylon or polyester or even fur-like materials”. This type cover would be relatively expensive and would not afford the ultimate hygienic protection to the user. In addition, Steadman discloses an overlapping closure means, which requires adhesive material closure strips, such as the material made by Velcro, to hold the cover in position. Alternatively, Steadman suggests using hooks, snaps or buttons to close the cover. U.S. Pat. No. 6,560,335 (Zohn) discloses Disposable sanitary covers for the earpiece mouthpiece and handle of telephone handsets. The covers are designed to provide universal fit to the earpiece or mouthpiece, regardless of its shape. U.S. Pat. No. 5,862,215 (Garriette) describes a protective cover for a telephone receiver mouthpiece or earpiece which comprises a thin, flexible sheet having a bounding perimeter, the sheet shaped and sized to fit over the earpiece or mouthpiece end portion of the receiver; and elastic band structure extending along or near the perimeter to collapse the perimeter adjacent the receiver end portion carrying the earpiece or mouthpiece, for holding the sheet in removable, yet yieldably resilient covering relation to the earpiece or mouthpiece; the sheet sized to loosely cover the receiver end portion.

With all the various arrangements of shapes and materials in telephone covers, the basic requirements of a sanitary cover still remain unmet. None of these cover devices accounts for the need to remove a cover without his/her hands contacting or coming into close contact with the cover surface and materials. Therefore, there remains a need for a telephone cover device that provides for easy removal and disposal of the device without requiring the telephone user to contact the surface or materials of the cover after the cover has been contaminated following use.

### SUMMARY OF THE INVENTION

The present invention provides a protective cover system for a telephone device that prevents germ contamination of the telephone during its use. This cover system provides covers for both the receiver and transmitter portions of a telephone device along a connecting element that connects the receiver and transmitter covers. This connecting element provides a convenient means to remove the covers from the telephone once the user has completed a conversation on the telephone device.

The telephone protective system comprises a pair of protective covers (one cover for the receiver (earpiece) and one for the transmitter (mouthpiece) portions of the telephone). Each cover further comprises a thin sheet of a flexible material. Each cover is shaped and sized to securely fit over the earpiece or mouthpiece ends of the telephone. In order to firmly secure the covers to the telephone, each cover can contain an elastic band material extending along or near the perimeter to collapse the perimeter adjacent the receiver end portion carrying the earpiece or mouthpiece, for holding the sheet in removable, yet yieldably resilient covering relation to the earpiece or mouthpiece.

The telephone protective system further comprises a connector element that is attached to both protective covers. This connector element can have elasticity properties. In addition, this connector element can fit either loosely or tightly against the telephone handle. At the completion of the telephone conversation, the user can pull the connector element and remove both covers from the telephone. Once the covers are removed, the user can hold the connector element and can dispose of the germ-contaminated covers without the user's hand coming into contact with the contaminated covers.

### DESCRIPTION OF THE DRAWINGS

FIG. 1 is a conceptual illustration of the structure of the present invention.

FIG. 2 is a view of the protective cover for the earpiece or mouthpiece of a telephone in accordance with the present invention.

FIG. 3 is a view of the elastic connector of the present invention.

FIG. 4 is a view of a protective cover with the elastic connector member attached thereto in accordance with the present invention.

FIG. 5 is a front view of the protective cover system of the present invention attached to a telephone device.

FIG. 6 is a side view of the protective cover system of the present invention attached to a telephone device.

FIG. 7 is a front and side view of the protective cover system of the present invention attached to a telephone device.

### DETAILED DESCRIPTION OF THE INVENTION

The present invention provides a protective cover system for a telephone device that prevents germ contamination of the telephone during use. This cover system provides covers for both the receiver and transmitter portions of a telephone device along an elastic connecting element that connects to the receiver and transmitter covers. This connecting element provides a convenient means to remove the covers from the telephone once the user has completed a conversation on the telephone device.

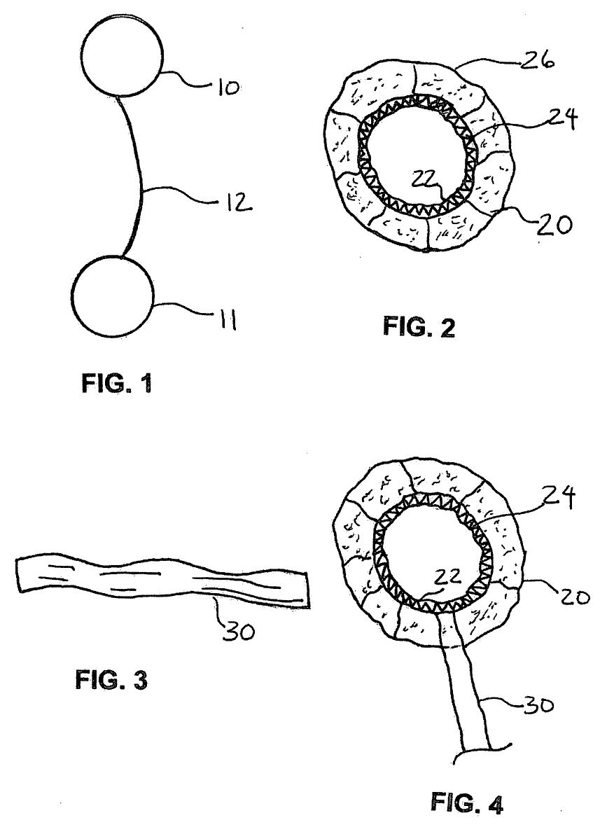

FIG. 1 illustrates the structural concept of the present invention. As previously described, the present invention comprises a pair of telephone covers 10 and 11. These covers fit over the earpiece and mouthpiece portions of a telephone device. A connector element 12 can be made preferably of an elastic material and attaches to both covers 10 and 11. The connector element provides a means for the user to remove the germ-contaminated covers after the completion of the telephone conversation without requiring the user to handle the covers.

FIG. 2 shows a protective cover used in the present invention. The protective cover 20 includes a thin, flexible material. This material should have the capability to prevent the passage of fluids. This material can have qualities of an air filter. The piece of material used to form the cover can be a flat piece of material having an edge referred to as the perimeter 22. The sheet is shaped and sized to fit over the earpiece or mouthpiece end portion of the telephone. The cover is attached to the telephone by covering the earpiece or mouthpiece with the sheet and securing the cover with an elastic band material 24 incorporated into the cover material along the perimeter edge of the material. When the elastic material retracts it cases the cover edge containing the elastic material to collapse around the telephone piece and thereby secure the cover to the telephone. For example looping band 24, extends along or near the perimeter 26, to collapse that perimeter, as shown in FIG. 2. The opening defined by the circularly looping, contracted band in FIG. 2 can very depending on the elasticity of the band material but with typical telephones the contracted band is approximately 1½ inches in diameter. The overall diameter of the flat, collapsed sheet material is about 3 inches with a typical telephone.

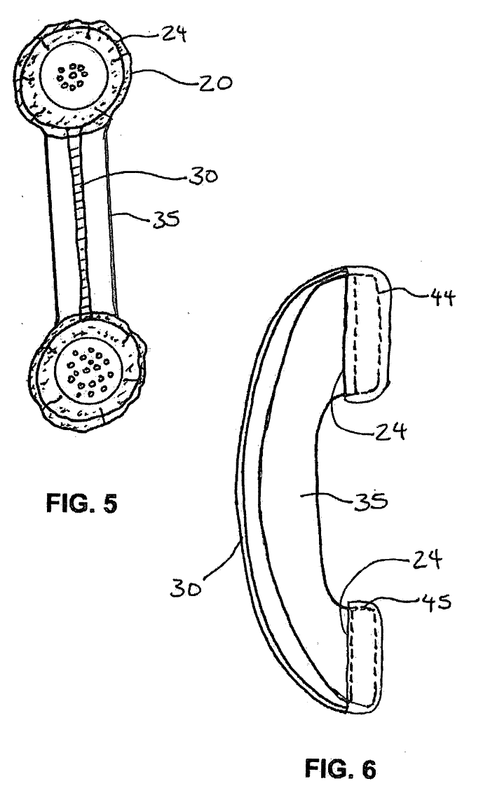

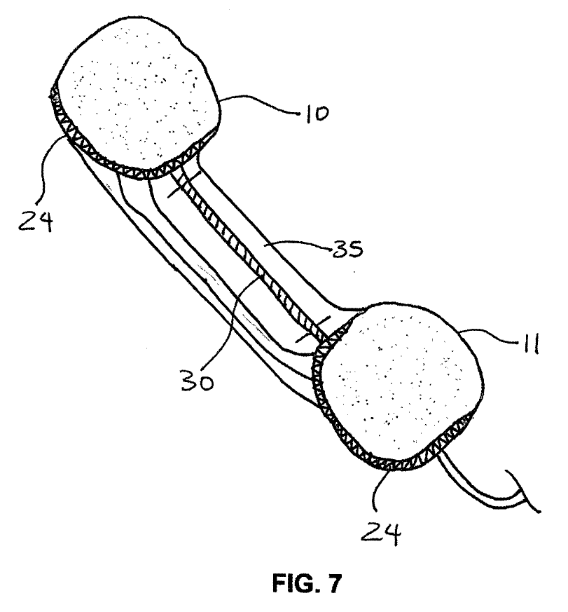

FIG. 3 shows an elastic band 30 that serves as the connector element that attaches the two covers. FIG. 4 shows the elastic band 30 attached to the cover 20. The elastic band 30 can be positioned on the front side of the telephone handle 35 (FIG. 5 or FIG. 7) or the backside of the handle 35 (FIG. 6).

FIGS. 5 and 6 show the covers 10 and 11 as manually applied to the mouthpieces 44 and 45, in which condition the elastic band 24 incorporated in a cover is partially expanded to clamp a cover to each mouthpiece. Accordingly, the elastic perimeter is collapsed adjacent the receiver/transmitter mouthpiece ends. The covers are removable, yet yieldably resilient, to firmly cover the end pieces. Such coverage is typically loose, so that the cover is easily applied to the telephone end pieces. The covers are removed by manually pulling the elastic band 30 that is attached to the covers 10 and 11. The connector element can be elastic but can have some slack to better facilitate grasping and pulling the elastic band in order to remove the covers. In FIG. 5, the elastic band 30 is positioned on the inside of the telephone handle. In FIG. 6, the elastic band 30 is positioned on the outer side of the telephone handle.

The cover materials can be comprised of UNIFIL, a non-woven, synthetic resinous material, for example rayon, about 0.005 inches in thickness. UNIFIL is a product of Mid West Filtration Co., Fairfield, Ohio. Such material does not tear and facilitates repeated. Another cover material option is plastic material covers that may comprise UNIFIL, which has air permeability. Its thickness is about 5 mils, i.e., 0.005 inch.

FIG. 7 shows a front and side view of the telephone cover of the present invention attached to a telephone device. As shown, covers 10 and 11 cover the earpiece and mouthpiece and provide a barrier to prevent germs from contacting the earpiece and mouthpiece surfaces of the telephone. The elastic bands 24 secure the covers to the end pieces. Elastic band 30 attached to both covers provides a means to remove the covers from the telephone end pieces at the conclusion of telephone use.

In addition to the cover design shown in FIG. 7, there can also be alternative cover designs to account for antennas attached to the end pieces. This alternate design is especially applicable to use of the present invention on cellular telephone devices.

The present invention provides significant advantages over the current art. While the invention has been described using a limited number of embodiments, those skilled in the art, having the benefit of this disclosure, will appreciate that other variations are possible without departing from the scope of the invention as disclosed herein or from its true spirit. Accordingly, the scope of the invention should be limited only by the attached claims.

This description is intended for purposes of illustration only and should not be construed in a limiting sense. Only the language of the claims that follow should determine the scope of this invention. The term “comprising” within the claims is intended to mean “including at least” such that the recited listing of elements in a claim are an open group. “A,” “an” and other singular terms are intended to include the plural forms thereof unless specifically excluded.

I claim:

1. A germ protective telephone cover system for a telephone mouthpiece end portion and a telephone earpiece end portion comprising:
a pair of covers made of thin, flexible material having a bounding perimeter, the covers being shaped and sized to fit over a telephone end portion (earpiece or mouthpiece);
an elastic band incorporated into each of said pair of covers and extending along the cover perimeter to collapse the cover perimeter over an adjacent telephone end portion for holding the cover in removable and yieldably resilient relation to the earpiece end portion or mouthpiece end portion, said cover material sized to loosely cover the earpiece or mouthpiece end portion, said cover with elastic bands that extend along said edges and forming a retention means to retain the cover material over the telephone earpiece or mouthpiece, with said elastic bands in partially stretched condition; and
a strip of flexible material positioned between the pair of covers, the strip material having two ends, one end attached to each of the covers, said strip material providing a means to remove the covers from the telephone.

2. The germ protective telephone cover system as described in claim 1 wherein said strip of flexible material further comprises an elastic material.

3. The germ protective telephone cover system as described in claim 1 wherein said strip of flexible material has a length such that when the ends of said flexible material are attached to the said pair of covers, the length of the flexible material exceeds that length between the pair of covers and thereby creates slack in said flexible material, the slack facilitating a more efficient means to engage said flexible material for removing said covers.

4. The germ protective telephone cover system as described in claim 3 wherein said strip material is attached to said pair of covers such that said flexible material is positioned on an outer side of a telephone handle between the earpiece and mouthpiece of the telephone.

5. The germ protective telephone cover system as described in claim 3 wherein said strip material is attached to said pair of covers such that said flexible material is positioned on an inner side of a telephone handle between the earpiece and mouthpiece of the telephone.

6. The germ protective telephone cover system as described in claim 1 wherein said pair of covers further comprises a sterile and disposable material.
